(19) United States
(12) Patent Application Publication
(10) Pub. No.: US 2009/0070730 A1
(43) Pub. Date: Mar. 12, 2009

(54) METHOD AND APPARATUS FOR MODELING A VECTORIAL POLARIZATION EFFECT IN AN OPTICAL LITHOGRAPHY SYSTEM

(75) Inventors: Qiaolin Zhang, Sunnyvale, CA (US); Hua Song, San Jose, CA (US); Kevin D. Lucas, Austin, TX (US)

Correspondence Address: PVF -- SYNOPSYS, INC;c/o PARK, VAUGHAN & FLEMING LLP, 2820 FIFTH STREET, DAVIS, CA, 95618-7759, US

(73) Assignee: SYNOPSYS, INC., Mountain View, CA (US)

(21) Appl. No.: 11/851,011

(22) Filed: Sep. 6, 2007

(51) Int. Cl. G06F 17/50

(52) U.S. Cl. 716/19

(57) ABSTRACT

One embodiment of the present invention provides a system that accurately models polarization effects in an optical lithography system for manufacturing integrated circuits. During operation, the system starts by receiving a polarization-description grid map for a lens pupil in the optical lithography system. The system then constructs a pupil-polarization model by defining a vectorial matrix at each grid point in the grid map, wherein the vectorial matrix specifies a pupil-induced polarization effect on an incoming optical field at the grid point. Next, the system enhances a lithography model for the optical lithography system by incorporating the pupil-polarization model into the lithography/OPC model. The system then uses the enhanced lithography model to perform convolutions with circuit patterns on a mask in order to simulate optical lithography pattern printing.

### RELATED APPLICATION

The subject matter of this application is related to the subject matter in a co-pending non-provisional application by the inventors Qiaolin Zhang and Hua Song, and filed on the same day as the instant application entitled, “Modeling an Arbitrarily Polarized Illumination Source in an Optical Lithography System,” having Ser. No. TO BE ASSIGNED, and filing date TO BE ASSIGNED (Attorney Docket No. SNPS-0986-2).

### BACKGROUND

1. Field of the Invention

The present invention relates to the process of semiconductor manufacturing. More specifically, the present invention relates to a method and an apparatus for accurately modeling polarization state changes for an optical image imposed by a projection lens pupil in an optical lithography system used in a semiconductor manufacturing process.

2. Related Art

Dramatic improvements in semiconductor integration circuit (IC) technology presently make it possible to integrate hundreds of millions of transistors onto a single semiconductor IC chip. These improvements in integration densities have largely been achieved through corresponding improvements in semiconductor manufacturing technologies. Semiconductor manufacturing technologies typically include a number of processes which involve complex physical and chemical interactions. Since it is almost impossible to find exact formulae to predict the behavior of these complex interactions, developers typically use process models which are fit to empirical data to predict the behavior of these processes. In particular, various process models have been integrated into Optical Proximity Correction (OPC)/Resolution Enhancement Technologies (RET) for enhancing imaging resolutions during optical lithographic processes.

More specifically, during an OPC/RET modeling process, one or more process models are used to make corrections to a semiconductor chip layout in a mask to compensate for undesirable effects of complex lithographic processes. An OPC/RET model (“OPC model” hereafter) is typically composed of a physical optical model and an empirical process model. An OPC simulation engine uses the OPC model to iteratively evaluate and modify edge segments in the mask layout. In doing so, the OPC simulation engine computes the correct mask patterns which produce physical patterns on wafer that closely match a desired design layout. Note that the effectiveness of the corrected mask patterns is typically limited by the accuracy of the OPC model.

As Moore's law drives IC features to increasingly smaller dimensions (which are now in the deep submicron regime), a number of physical effects, which have been largely ignored or oversimplified in existing OPC models, are becoming increasingly important for OPC model accuracy. Hence, it is desirable to provide more comprehensive, physics-centric descriptions for these physical effects to improve OPC model accuracy.

In particular, the polarization behavior of an optical lithographic system is one of the physical effects that are inadequately represented in a traditional OPC model. While existing OPC models can model the polarization behavior of light and optical lithographic systems in some very limited aspects (i.e., polarization-state-dependent refraction, transmission and reflection in thin films on a wafer), these models are not capable of modeling the more complex polarization-state-dependent vectorial behavior of light in an illumination source and in a projection lens pupil of the lithographic system.

More specifically, the existing OPC models treat the illumination source as either an unpolarized light or a single state (TE/TM/X/Y) polarized light, while a realistic illumination source can have an arbitrarily polarized state. Furthermore, the existing OPC models treat a projection lens system as a simple scalar lens pupil, which acts on the incoming optical field homogeneously and independently of the polarization state of the optical field. Consequently, these models cannot accurately and adequately capture the polarization state change of the incident field imposed by the projection lens system. These oversimplified projection lens models make the modeling accuracy and fidelity of an OPC model inadequate for ever-decreasing feature sizes.

Hence, what is needed is a method and an apparatus that can accurately model a polarization state change imposed by a projection lens system without the above-described problems.

### SUMMARY

One embodiment of the present invention provides a system that accurately models polarization effects in an optical lithography system for manufacturing integrated circuits. During operation, the system starts by receiving a polarization-description grid map for a lens pupil in the optical lithography system. The system then constructs a pupil-polarization model by defining a vectorial matrix at each grid point in the grid map, wherein the vectorial matrix specifies a pupil-induced polarization effect on an incoming optical field at the grid point. Next, the system enhances a lithography model for the optical lithography system by incorporating the pupil-polarization model into the lithography/OPC model. The system then uses the enhanced lithography model to perform convolutions with circuit patterns on a mask in order to simulate optical lithography pattern printing.

In a variation on this embodiment, the system defines the vectorial matrix at each grid point by specifying each entry in the vectorial matrix as a function of the grid point location.

In a further variation on this embodiment, the vectorial matrix at each grid point is a Jones matrix.

In a further variation, at each grid point P=(x, y) in a x-y coordinates, the Jones matrix is a 2 by 2 matrix

$$[ \begin{matrix}{J}_{xx} ( P ) & {J}_{xy} ( P ) \\ {J}_{yx} ( P ) & {J}_{yy} ( P )\end{matrix} ] ,$$

wherein Jₓₓ denotes the conversion of an x-polarized electrical field at the lens pupil entrance to an x-polarized electrical field at the lens pupil exit; J_{xy} denotes the conversion of a y-polarized electrical field at the lens pupil entrance to an x-polarized electrical field at the lens pupil exit; J_{yx} denotes the conversion of an x-polarized electrical field at the lens pupil entrance to a y-polarized electrical field at the lens pupil exit; J_{yy} denotes the conversion of a y-polarized electrical field at the lens pupil entrance to a y-polarized electrical field at the lens pupil exit.

In a further variation, the vectorial matrix at each grid point can include a Muller matrix; a Jones matrix; or a coherency transfer matrix.

In a variation on this embodiment, the system incorporates the pupil-polarization model into the lithography model by modifying a transfer matrix of the lithography model with the vectorial matrix, wherein the transfer matrix does not include the pupil-induced polarization effect.

In a further variation, the system modifies the transfer matrix of the lithography model with the vectorial matrix by multiplying a total transfer matrix by the vectorial matrix.

In a further variation, the system extracts kernels for the lithography model from the modified transfer matrix.

### BRIEF DESCRIPTION OF THE FIGURES

FIG. 1 illustrates various steps in the design and fabrication of an integrated circuit in accordance with an embodiment of the present invention.

FIG. 2A illustrates a typical optical lithography system in accordance with an embodiment of the present invention.

FIG. 2B illustrates the process of defining the lens-pupil-polarization-effect on a lens pupil plane in accordance with an embodiment of the present invention.

FIG. 3A illustrates the amplitudes of each Jones matrix entry associated with an exemplary Jones pupil in accordance with an embodiment of the present invention.

FIG. 3B illustrates the phases of each Jones matrix entry associated with the same exemplary Jones pupil in accordance with an embodiment of the present invention.

FIG. 4 presents a flowchart illustrating the process of modeling the projection lens-induced polarization effect in accordance with an embodiment of the present invention.

FIG. 5 illustrates the process of projecting an optical image from a projection lens onto a wafer in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Integrated Circuit Design Flow

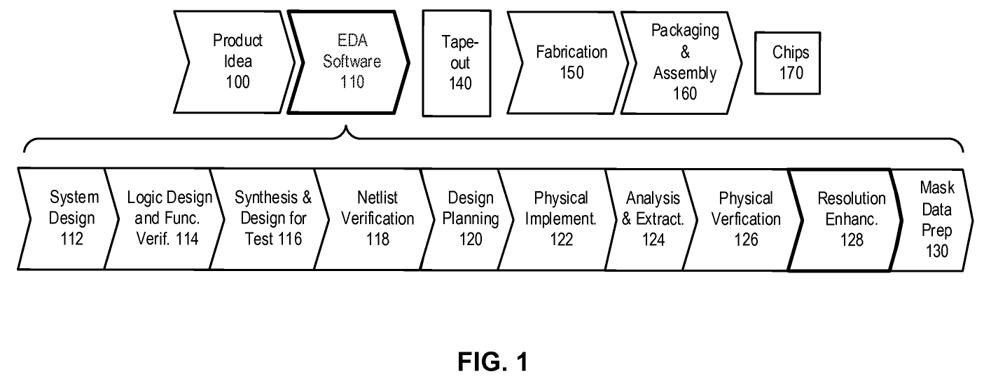

FIG. 1 illustrates various steps in the design and fabrication of an integrated circuit in accordance with an embodiment of the present invention.

The process starts with the product idea (step 100) which is realized using an EDA software design process (step 110). When the design is finalized, it can be taped-out (event 140). After tape out, the fabrication process (step 150) and packaging and assembly processes (step 160) are performed which ultimately result in finished chips (result 170).

The EDA software design process (step 110), in turn, comprises steps 112-130, which are described below. Note that the design flow description is for illustration purposes only. This description is not meant to limit the present invention. For example, an actual integrated circuit design may require the designer to perform the design steps in a different sequence than the sequence described below. The following discussion provides further details of the steps in the design process.

System design (step 112): The designers describe the functionality that they want to implement. They can also perform what-if planning to refine functionality, check costs, etc. Hardware-software architecture partitioning can occur at this stage. Exemplary EDA software products from Synopsys, Inc. that can be used at this step include Model Architect, Saber, System Studio, and DesignWare® products.

Logic design and functional verification (step 114): At this stage, the VHDL or Verilog code for modules in the system is written and the design is checked for functional accuracy. More specifically, the design is checked to ensure that it produces the correct outputs. Exemplary EDA software products from Synopsys, Inc. that can be used at this step include VCS, VERA, DesignWare®, Magellan, Formality, ESP and LEDA products.

Synthesis and design for test (step 116): Here, the VHDL/Verilog is translated to a netlist. The netlist can be optimized for the target technology. Additionally, tests can be designed and implemented to check the finished chips. Exemplary EDA software products from Synopsys, Inc. that can be used at this step include Design Compiler®, Physical Compiler, Test Compiler, Power Compiler, FPGA Compiler, Tetramax, and DesignWare® products.

Netlist verification (step 118): At this step, the netlist is checked for compliance with timing constraints and for correspondence with the VHDL/erilog source code. Exemplary EDA software products from Synopsys, Inc. that can be used at this step include Formality, PrimeTime, and VCS products.

Design planning (step 120): Here, an overall floorplan for the chip is constructed and analyzed for timing and top-level routing. Exemplary EDA software products from Synopsys, Inc. that can be used at this step include Astro and IC Compiler products.

Physical implementation (step 122): The placement (positioning of circuit elements) and routing (connection of the same) occurs at this step. Exemplary EDA software products from Synopsys, Inc. that can be used at this step include the Astro and IC Compiler products.

Analysis and extraction (step 124): At this step, the circuit function is verified at a transistor level; this in turn permits what-if refinement. Exemplary EDA software products from Synopsys, Inc. that can be used at this step include AstroRail, PrimeRail, Primetime, and Star RC/XT products.

Physical verification (step 126): In this step, the design is checked to ensure correctness for manufacturing, electrical issues, lithographic issues, and circuitry. Exemplary EDA software products from Synopsys, Inc. that can be used at this step include the Hercules product.

Resolution enhancement (step 128): This step involves geometric manipulations of the layout to improve manufacturability of the design. Exemplary EDA software products from Synopsys, Inc. that can be used at this step include Progen, Proteus, ProteusAF, and PSMGen products.

Mask data preparation (step 130): This step provides the “tape-out” data for production of masks to produce finished chips. Exemplary EDA software products from Synopsys, Inc. that can be used at this step include the CATS(R) family of products.

Embodiments of the present invention can be used during one or more of the above-described steps. Specifically, one embodiment of the present invention can be used during resolution enhancement step 128.

### Terminology

Throughout the specification, the following terms have the meanings provided herein, unless the context clearly dictates otherwise. The terms “incident light,” “incident optical field,” and “incident electrical field” are used interchangeably to refer to a light impinging upon an optical component, in particular a projection lens of the lithography system. The terms “projection lens,” “lens pupil,” and “projection lens pupil” all refer to a projection lens system of the lithography system, wherein as a vectorial optical field passes through the projection lens system, a polarization state of the optical field can change because of the polarization effect on the optical field imposed by the projection lens system.

### Overview

Embodiments of the present invention provide a vectorial OPC modeling technique, which is capable of modeling a polarization effect of an optical lithography system component imposed on an arbitrarily polarized optical field impinging upon the component. More specifically, this OPC modeling technique provides a point-by-point vectorial-polarization-impact description on a projection lens to describe the polarization state transformation of the incident optical field from the entrance pupil to the exit pupil of the projection lens. Embodiments of the present invention select a matching form of vectorial description based on a given form of optical field representation, such as in Stokes parameters, Jones vectors, or coherency matrices.

### Vectorial Polarization Effect in an Optical Lithography System

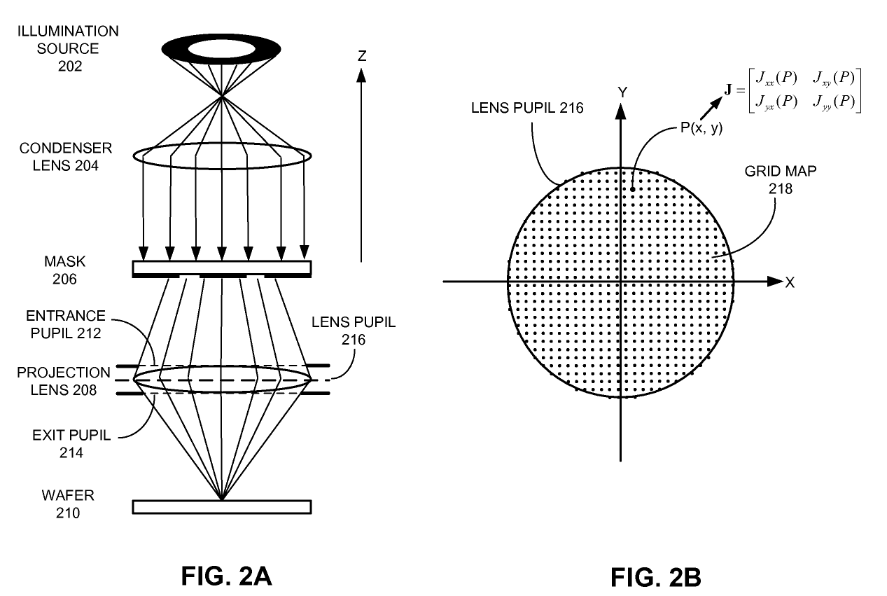

FIG. 2A illustrates a typical optical lithography system in accordance with an embodiment of the present invention. As shown in FIG. 2A, optical radiation emanates from an illumination source 202, which can be any suitable source of radiation such as a laser, and can be of any suitable wavelength for photoresist exposure. In one embodiment of the present invention, a specially configured illumination pupil is placed in front of illumination source 202 to produce a modified illumination. This optical radiation passes through a condenser lens 204, and then through a mask 206. Mask 206 defines integrated circuit patterns to be printed (i.e., fabricated) onto a wafer 210.

The image of mask 206 passes through projection lens 208, which focuses the image onto wafer 210. Note that projection lens 208 can include a plurality of lenses configured to achieve a high-NA and other desirable optical properties. During operation, the above-described lithograph system transfers circuitry defined by mask 206 onto wafer 210. Wafer 210 is a semiconductor wafer coated with a thin-film stack. The thin-film stack typically comprises a photoresist layer, or more generally any item to be exposed by the system.

More specifically, a vectorial optical field carrying the mask image enters projection lens 208 through a virtual entrance pupil 212 of projection lens 208 and exits projection lens 208 through a virtual exit pupil 214. Mathematically, we represent the vectorial optical field as an electrical field E (“E field” hereafter). Note that an incident E field can have a particular polarization state, such as a linear polarization, a circular polarization, or an elliptical polarization. Because projection lens 208 typically has a complicated structure and optical characteristics, the incident E field interacts with each optical component within projection lens 208, and each of these optical components can have a unique polarization effect on the polarization state of the E field. As a result, the polarization state of the incident E field changes as the E field arrives at exit pupil 214. We refer to this polarization state change of the incident optical field imposed by the projection lens as a lens-pupil-polarization-effect.

In the following discussion, we define the central axis (i.e., the vertical axis) of the lithography system in FIG. 2A as the z-axis. Hence, a plane in the lithography system perpendicular to the z-axis is an x-y plane, including both entrance pupil 212 and exit pupil 214. Note that the incident E field can be decomposed into two perpendicular components Eₓ and E_{y} in a given x-y plane. For example, a circular polarized electrical field can be decomposed into linearly polarized fields Eₓ and E_{y} which have the same amplitude but are 90 degrees out of phase. Note that the two polarization components can be used to construct a Jones vector

$$[ \begin{matrix}{E}_{x} \\ {E}_{y}\end{matrix} ]$$

for the incident E field. We also define a lens pupil 216 positioned between entrance pupil 212 and exit pupil 214, and perpendicular to the z-axis. Hence, lens pupil 216 is also in an x-y plane. In one embodiment of the present invention, lens pupil 216 coincides with exit pupil 214.

FIG. 2B illustrates the process of defining the lens-pupil-polarization-effect on lens pupil 216 in accordance with an embodiment of the present invention. More specifically, FIG. 2B provides an x-y plane view of lens pupil 216 in FIG. 2A, wherein lens pupil 216 is shown as a circular aperture in FIG. 2B. FIG. 2B also illustrates a two-dimensional (2D) grid map 218 composed of a 2D array of grid points. Because lens pupil 216 is in an x-y plane, grid map 218 is defined in the x-y plane so that each grid point in grid map 218 is associated with location coordinates P(x, y). Embodiments of the present invention can also use other forms of grid maps different from grid map 218. In one embodiment, a grid map is defined in a radial coordinate system in lens pupil 216, so that each grid point is associated with radial coordinates P(r, θ).

In one embodiment of the present invention, at each grid point P(x, y) within lens pupil 216, a vectorial matrix is assigned to that grid point to specify the lens-pupil-polarization-effect at grid point P(x, y). More specifically, for an incident E field impinging on the grid point P(x, y) at entrance pupil 212, this vectorial matrix specifies the polarization state change of the incident E field imposed by projection lens 208 as the E field passes through projection lens 208 to exit pupil 214. Note that this polarization state change can include changes to both Eₓ and E_{y} components.

In one embodiment of the present invention, the lens-pupil-polarization-effect at a grid point P(x, y) is specified by a Jones matrix. More specifically, a 2 by 2 Jones matrix J is defined at each grid point P(x, y) in grid map 218 inside lens pupil 216, wherein each matrix entry in the Jones matrix at P(x, y) is a function of P(x, y). Consequently, we refer to this process as a point-by-point description of the lens-pupil-polarization-effect. Note that this point-by-point-description model effectively captures spatial variations of the vectorial polarization effect in the lens pupil. We refer to this lens pupil model comprising a point-by-point Jones matrix description of the vectorial polarization effect as a Jones pupil model.

In one embodiment of the present invention, Jones matrix J is defined as

$$[ \begin{matrix}{J}_{xx} ( P ) & {J}_{xy} ( P ) \\ {J}_{yx} ( P ) & {J}_{yy} ( P )\end{matrix} ] ,$$

wherein each entry in J is a complex number that specifies both amplitude and phase transformation. More specifically, at a grid point P(x, y), Jₓₓ(P) converts an x-polarized electrical field at the entrance pupil to an x-polarized electrical field at the exit pupil; J_{xy}(P) converts a y-polarized electrical field at the entrance pupil to an x-polarized electrical field at the exit pupil; J_{yx}(P) converts an x-polarized electrical field at the entrance pupil to a y-polarized electrical field at the exit pupil; and J_{yy}(P) converts a y-polarized electrical field at the entrance pupil to a y-polarized electrical field at the exit pupil.

Note that Jones matrix J can be directly applied to the Jones vector representation of an incident E field and produces polarization state changes of the E field between the entrance and exit pupil. This process can be expressed as

$$[ \begin{matrix}{E}_{x}^{output} \\ {E}_{y}^{output}\end{matrix} ] = [ \begin{matrix}{J}_{xx} & {J}_{xy} \\ {J}_{yx} & {J}_{yy}\end{matrix} ] [ \begin{matrix}{E}_{x}^{in} \\ {E}_{y}^{in}\end{matrix} ] . \qquad ( 1 )$$

Note that both the amplitudes and the phases of the Eₓ and E_{y} components are typically changed during this transformation.

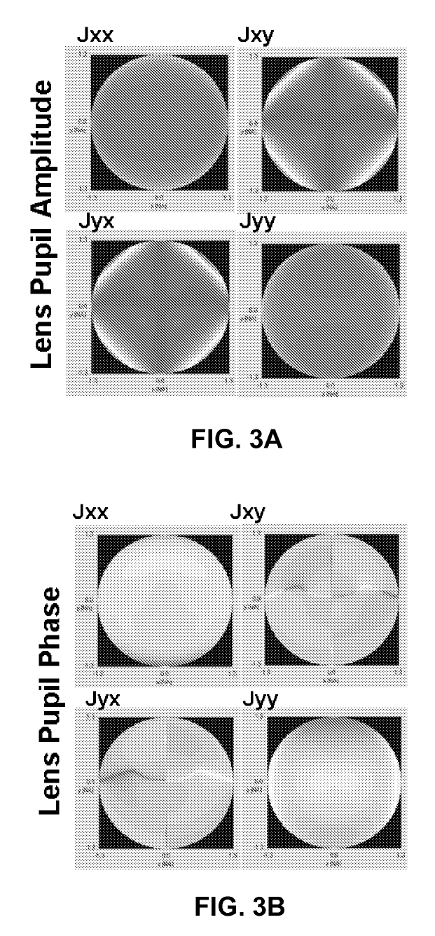

FIG. 3 illustrates different components of a Jones pupil in accordance with an embodiment of the present invention.

More specifically, FIG. 3A illustrates the amplitudes of each Jones matrix entry associated with an exemplary Jones pupil in accordance with an embodiment of the present invention, while FIG. 3B illustrates the phases of each Jones matrix entry associated with the same exemplary Jones pupil in accordance with an embodiment of the present invention. Note that the illustrated pupil-polarization behavior not only depends on the polarization state but also on the incident angle (i.e. a location on the pupil).

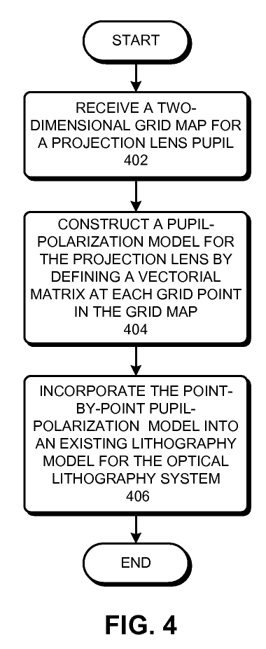

FIG. 4 presents a flowchart illustrating the process of modeling the lens-pupil-polarization-effect in accordance with an embodiment of the present invention. During operation, the system receives a 2D grid map for a projection lens pupil (step 402). Generally, embodiments of the present invention can use any suitable 2D grid maps. In one embodiment, the grid map is sufficiently dense so that a sufficient number of grid points is used to provide a high resolution of the polarization effects within the lens pupil. In one embodiment, the grid map has the same grid size in both x and y directions.

The system then constructs a pupil-polarization model for the projection lens by defining a vectorial matrix at each grid point in the grid map, wherein each vectorial matrix specifies the change of the polarization state of an incoming optical field between the entrance pupil and the exit pupil (step 404). In one embodiment of the present invention, this vectorial matrix can be obtained from the manufacturer of the lithography system where measurements of the lens polarization effect can be directly performed. This vectorial matrix can include but is not limited to a Muller matrix, a Jones matrix, and a coherency transfer matrix. We describe each of these matrix types in more detail below.

Next, the system incorporates the pupil-polarization model into an existing lithography model for the optical lithography system which does not include a point-by-point polarization model for the projection lens (step 406). In one embodiment of the present invention, the pupil-polarization model is used to modify a total transfer matrix of a photolithograph/OPC model. We describe the process of the incorporation of the polarization model in more detail below.

### Other Forms of Vectorial Matrix for a Projection Lens Pupil

Other than using Jones matrices, embodiments of the present invention provide other forms of vectorial matrix to describe the polarization state changes imposed by a lens pupil.

One embodiment of the present invention uses a Mueller matrix representation for the point-by-point description of a lens-pupil-polarization-effect. It is well known that a Muller matrix can be applied to a Stokes vector representation of a polarized optical field to reproduce the polarization effect of an optical element. More specifically, a Muller matrix transforms an incident Stokes vector S into an exiting (reflected, transmitted, or scattered) Stokes vector S′. In this embodiment, the lens-pupil-polarization-effect at a grid point P(x, y) is specified by a 4 by 4 Muller matrix M:

$$M = [ \begin{matrix}{m}_{00} ( P ) & {m}_{01} ( P ) & {m}_{02} ( P ) & {m}_{03} ( P ) \\ {m}_{10} ( P ) & {m}_{11} ( P ) & {m}_{12} ( P ) & {m}_{13} ( P ) \\ {m}_{20} ( P ) & {m}_{21} ( P ) & {m}_{22} ( P ) & {m}_{23} ( P ) \\ {m}_{30} ( P ) & {m}_{31} ( P ) & {m}_{32} ( P ) & {m}_{33} ( P )\end{matrix} ] ,$$

wherein each entry in the matrix is a real number specifying an aspect of the polarization state change.

Referring to FIG. 2B, embodiments of the present invention assign one Muller matrix to each grid point P(x, y) in the 2D grid map 218 on lens pupil 216, wherein each matrix entry in the Muller matrix at grid point P(x, y) is a function of P(x, y). Compared with using a single Muller matrix to represent the entire projection lens, this point-by-point description of the pupil polarization effect offers much higher resolution. Consequently, for an incident Stokes vector S, the polarization state changes between the entrance and the exit pupil can be expressed as:

$$[ \begin{matrix}{S}_{1}^{′} \\ {S}_{2}^{′} \\ {S}_{3}^{′} \\ {S}_{4}^{′}\end{matrix} ] = [ \begin{matrix}{m}_{00} ( P ) & {m}_{01} ( P ) & {m}_{02} ( P ) & {m}_{03} ( P ) \\ {m}_{10} ( P ) & {m}_{11} ( P ) & {m}_{12} ( P ) & {m}_{13} ( P ) \\ {m}_{20} ( P ) & {m}_{21} ( P ) & {m}_{22} ( P ) & {m}_{23} ( P ) \\ {m}_{30} ( P ) & {m}_{31} ( P ) & {m}_{32} ( P ) & {m}_{33} ( P )\end{matrix} ] [ \begin{matrix}{S}_{1} \\ {S}_{2} \\ {S}_{3} \\ {S}_{4}\end{matrix} ] \qquad ( 2 )$$

Another embodiment of the present invention uses coherency-transfer-matrix representation for the point-by-point description of a lens-pupil-polarization-effect. A coherency transfer matrix is typically applied to a coherency matrix representation of an incident electrical field, wherein the coherency matrix is used to represent a partially polarized, non-monochromatic optical field. Note that a non-monochromatic optical field is a stochastic process. Hence, a coherency matrix is composed of entries that represent time averaged intensities and correlations between components of an electric field. For example, a coherency matrix C can be expressed as:

$$C = [ \begin{matrix}〈 {E}_{x} {E}_{x}^{*} 〉 & 〈 {E}_{x} {E}_{y}^{*} 〉 \\ 〈 {E}_{y} {E}_{x}^{*} 〉 & 〈 {E}_{y} {E}_{y}^{*} 〉\end{matrix} ] = [ \begin{matrix}{C}_{xx} & {C}_{xy} \\ {C}_{yx} & {C}_{yy}\end{matrix} ] \qquad ( 3 )$$

wherein < > represents a time average operation. The coherency matrix transformation is given by:

C′=JCJ*. (4)

wherein J is a Jones matrix. Hence, the Jones matrices defined in the above-described Jones pupil can be used here to perform a coherency matrix transformation of Eqn. (4).

Note that although we describe three forms of vectorial matrix for the pupil polarization effect, the general technique of using a point-by-point description of the lens-pupil-polarization-effect is not meant to be limited to these particular forms. Other polarization description forms can also be used as long as they provide substantially the same amount of polarization information of the projection lens.

Incorporating the Pupil Polarization Model into a Lithography Model

Total Transfer Matrix

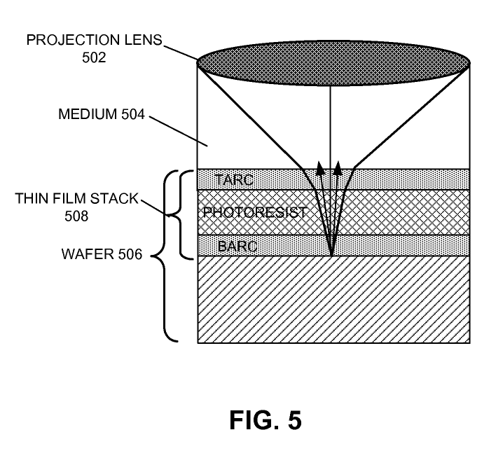

FIG. 5 illustrates the process of projecting an optical image from a projection lens onto a wafer in accordance with an embodiment of the present invention. As seen in FIG. 5, projection lens 502 focuses an optical image of an IC design through medium 504 onto wafer 506. Medium 504 can include air for low-NA projections lens systems. Medium 504 can also include a high-NA medium (e.g., for achieving hyper-NAs (NA>1)) in other projection lens systems. Note that when the optical image is focused by projection lens 502, a light beam entering medium 504 near the center of the lens has a different incident angle from a light beam entering medium 504 near the boundary region of the lens. A large incident angle beam near the lens boundary can have a greater z-polarized field component than a small incident angle beam near the center. In particular, in the high-NA media, this field vector rotation into z direction becomes more significant. In one embodiment of the present invention, a rotation matrix R can be constructed to account for the optical-field-vector rotation inside high-NA medium 504. Rotation matrix R can be subsequently used to correct a lithography model for the effect of high-NA medium 504. Note that this high-NA medium can also extend to a region above the entrance pupil of projection lens 502.

Also as illustrated in FIG. 5, the optical field enters wafer 506 after traveling through medium 504. More specifically, the optical field enters a thin-film stack 508 formed on a silicon substrate. Specifically, thin-film stack 508 comprises a top antireflective coating (TARC), a photoresist (PR) layer, and a bottom antireflective coating (BARC). Note that each of these layers can impose a certain amount of refraction, reflection, and absorption on the incident optical field as it travels through each layer of thin-film stack 508, wherein each of these optical effects then causes changes in the intensity and polarization state of the incident optical field. In one embodiment of the present invention, the film-stack induced optical effect is built into a thin-film matrix F, which can be subsequently used to correct a lithography model for the effect of light transmission in thin-film stack 508. Note that both matrices R and F are typically constructed as physical models instead of as empirical models.

In one embodiment of the present invention, the rotation matrix R and thin-film matrix F can be combined into a transfer matrix, for example, by multiplying matrix F with matrix R. The transfer matrix converts an electrical field from an object plane (projection lens) to an image plane in the photoresist. Note that a traditional transfer matrix does not consider the polarization effect of projection lens 502 imposed on the electrical field. Instead, projection lens 502 acts on the incident electrical field identically, independent of the polarization state.

In the traditional approaches, the transfer matrix is typically denoted by a 3 by 2-matrix Ψ with its six entries implemented as internal kernels. More specifically, transfer matrix

$$ψ = [ \begin{matrix}{ψ}_{xx} & {ψ}_{yx} \\ {ψ}_{xy} & {ψ}_{yy} \\ {ψ}_{xz} & {ψ}_{yz}\end{matrix} ] = F \cdot R ,$$

wherein each entry represents an aspect of the polarization state change imposed on an incident electrical field. For example, element ψ_{xy} denotes the conversion of an x-polarized electrical field to a y-polarized electrical field, while ψ_{yy} denotes the conversion of a y-polarized electrical field to a y-polarized electrical field.

Modifying the Transfer Matrix with the Pupil Vectorial Matrix

Embodiments of the present invention use the above-described lens-pupil-polarization model to modify the traditional transfer matrix of the lithography system. In one embodiment of the present invention, a new transfer matrix is obtained by multiplying the traditional transfer matrix with the Jones matrix, i.e., ψ_{new}=ψ·J=F·R·J. Hence, in an arbitrary pupil polarization (Jones pupil) modeling, the new transfer matrix ψ_{new} can be expressed as:

$$\begin{matrix}{ψ}_{new} = ψ \cdot J = [ \begin{matrix}{ψ}_{xx} & {ψ}_{yx} \\ {ψ}_{xy} & {ψ}_{yy} \\ {ψ}_{xz} & {ψ}_{yz}\end{matrix} ] [ \begin{matrix}{J}_{xx} ( P ) & {J}_{xy} ( P ) \\ {J}_{yx} ( P ) & {J}_{yy} ( P )\end{matrix} ] \\ = [ \begin{matrix}{ψ}_{xx} \cdot {J}_{xx} + {ψ}_{yx} \cdot {J}_{yx} & {ψ}_{xx} \cdot {J}_{xy} + {ψ}_{yx} \cdot {J}_{yy} \\ {ψ}_{xy} \cdot {J}_{xx} + {ψ}_{yy} \cdot {J}_{yx} & {ψ}_{xy} \cdot {J}_{xy} + {ψ}_{yy} \cdot {J}_{yy} \\ {ψ}_{xz} \cdot {J}_{xx} + {ψ}_{yz} \cdot {J}_{yx} & {ψ}_{xz} \cdot {J}_{xy} + {ψ}_{yz} \cdot {J}_{yy}\end{matrix} ]\end{matrix} \qquad ( 5 )$$

According to the above-described conventions, the first entry ψₓₓ.Jₓₓ+ψ_{yx}.J_{yx} is understood as the following. The first term in the entry operates from the right (Jₓₓ) to the left (ψₓₓ). More specifically, Jₓₓ denotes the conversion of an x-polarized electrical field at the entrance pupil to an x-polarized electrical field at the exit pupil. Next, ψₓₓ denotes the conversion of the x-polarized electrical field at the exit pupil to an x-polarized electrical field in the photoresist. Similarly, in the second term in the entry, J_{yx} denotes the conversion of an x-polarized electrical field at the entrance pupil to an y-polarized electrical field at the exit pupil. Next, ψ_{yx} denotes the conversion of the y-polarized electrical field at the exit pupil to an x-polarized electrical field in the photoresist. Hence, the combined effect of the first entry in the modified transfer matrix converts an x-polarized electrical field at the entrance pupil to another x-polarized electrical field in the photoresist. In the same manner, one can appreciate the other entries in the modified transfer matrix. For example, the lower right entry effectively converts a y-polarized electrical field at the entrance pupil to a z-polarized electrical field in the photoresist. Consequently, we can write the modified transfer matrix incorporating a Jones pupil as:

$${ψ}_{new} = [ \begin{matrix}Kjones\_pupXX & Kjones\_pupYX \\ Kjones\_pupXY & Kjones\_pupYY \\ Kjones\_pupXZ & Kjones\_pupYZ\end{matrix} ] , \qquad ( 6 )$$

wherein the entries are used as internal kernels in the modified lithography model. In one embodiment of the present invention, the modified lithography model is used to perform convolutions with circuit patterns on a mask in order to simulate optical lithography pattern printing. In one embodiment of the present invention, the circuit patterns on a mask are convolved with the modified lithography model in the spatial domain. In another embodiment of the present invention, the circuit patterns on a mask are convolved with the modified lithography model in the spatial frequency domain.

### Other Variations

One embodiment of the present invention decomposes an incident electrical field into a transverse-electric (TE) component E_{TE} and a transverse-magnetic (TM) component E_{TM}. This decomposition technique depends on both an incident angle and a plane of incident of a given electrical field vector. In this embodiment, the coordinates for the two field components are particular to the direction of electrical field propagation. Hence, in order to apply a Jones matrix to the vector

$$[ \begin{matrix}{E}_{TE} \\ {E}_{TM}\end{matrix} ] ,$$

one embodiment of the present invention first performs a rotation transformation to change a Jones matrix in the x-y coordinates into a Jones matrix in the TE and TM coordinates. The process then applies the rotated Jones matrix to the vector

$$[ \begin{matrix}{E}_{TE} \\ {E}_{TM}\end{matrix} ] .$$

Note that for the above-described Jones pupil model, some or all of the Jones matrices need to be updated based on the electrical field vector at an associated grid point.

Note that the general technique of constructing a point-by-point vectorial-polarization-impact model is not limited to a projection lens, and can be extended to other optical components within a lithography system. For example, one can construct such a vectorial-polarization-impact model for the condenser lens, for the photomask, or for the pellicle film, and subsequently integrate the model into an overall transfer matrix of the lithography system.

### CONCLUSION

Embodiments of the present invention provide an independent, physics-centric vectorial model for a projection lens pupil. Consequently, lens pupil related parameters do not need to be regressed with other OPC model parameters during the model calibration process. This facilitates achieving high model fidelity and accuracy, and avoiding model over-fitting which can occur with too many fitting parameters in the empirical model or by distorting empirical models to compensate for the inaccuracy or absence of a vectorial pupil model.

Embodiments of the present invention facilitate high accuracy vectorial modeling of the pupil through a point-by-point description of the polarization state change imposed by the pupil, which can be specified on an arbitrary 2D grid map. Test results after including the vectorial models into an OPC/RET model have shown <0.5 nm CD error for 45 nm technology node and beyond.

The related application listed above provides an illumination-source-polarization-state model, which includes a point-by-point polarization-state description of an illumination source. Embodiments of the present invention combine the point-by-point polarization effect model for the lens pupil with the point-by-point polarization model for the illumination source to provide a more comprehensive, physics-centric vectorial polarization model for the lithography system.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for accurately modeling polarization effects in an optical lithography system for manufacturing integrated circuits, the method comprising:
receiving a grid map for a lens pupil in the optical lithography system;
constructing a pupil-polarization model by defining a vectorial matrix at each grid point in the grid map, wherein the vectorial matrix specifies a pupil-induced polarization effect on an incoming optical field at the grid point;
enhancing a lithography model for the optical lithography system by incorporating the pupil-polarization model into the lithography model; and
using the enhanced lithography model to perform convolutions with circuit patterns on a mask in order to simulate optical lithography pattern printing.

2. The method of claim 1, wherein defining the vectorial matrix at each grid point involves specifying each entry in the vectorial matrix as a function of the grid point location.

3. The method of claim 2, wherein the vectorial matrix at each grid point is a Jones matrix.

4. The method of claim 3, wherein at each grid point P=(x, y) in an x-y coordinate, the Jones matrix is a 2 by 2 matrix
$$[ \begin{matrix}{J}_{xx} ( P ) & {J}_{xy} ( P ) \\ {J}_{yx} ( P ) & {J}_{yy} ( P )\end{matrix} ] ,$$
wherein
Jₓₓ denotes the conversion of an x-polarized electrical field at the lens pupil entrance to an x-polarized electrical field at the lens pupil exit;
J_{xy} denotes the conversion of a y-polarized electrical field at the lens pupil entrance to an x-polarized electrical field at the lens pupil exit;
J_{yx} denotes the conversion of an x-polarized electrical field at the lens pupil entrance to a y-polarized electrical field at the lens pupil exit; and
J_{yy} denotes the conversion of a y-polarized electrical field at the lens pupil entrance to a y-polarized electrical field at the lens pupil exit.

5. The method of claim 2, wherein the vectorial matrix at each grid point can include:
a Muller matrix;
a Jones matrix; or
a coherency transfer matrix.

6. The method of claim 1, wherein incorporating the pupil-polarization model into the lithography model involves modifying a transfer matrix of the lithography model with the vectorial matrix, wherein the transfer matrix does not include the pupil-induced polarization effect.

7. The method of claim 6, wherein modifying the transfer matrix of the lithography model with the vectorial matrix involves multiplying a total transfer matrix by the vectorial matrix.

8. The method of claim 6, wherein the method further comprises extracting kernels for the lithography model from the modified transfer matrix.

9. A computer-readable storage medium storing instructions that when executed by a computer cause the computer to perform a method for accurately modeling polarization effects in an optical lithography system for manufacturing integrated circuits, the method comprising:
receiving a grid map for a lens pupil in the optical lithography system;
constructing a pupil-polarization model by defining a vectorial matrix at each grid point in the grid map, wherein the vectorial matrix specifies a pupil-induced polarization effect on an incoming optical field at the grid point;
enhancing a lithography model for the optical lithography system by incorporating the pupil-polarization model into the lithography model; and
using the enhanced lithography model to perform convolutions with circuit patterns on a mask in order to simulate optical lithography pattern printing.

10. The computer-readable storage medium of claim 9, wherein defining the vectorial matrix at each grid point involves specifying each entry in the vectorial matrix as a function of the grid point location.

11. The computer-readable storage medium of claim 10, wherein the vectorial matrix at each grid point is a Jones matrix.

12. The computer-readable storage medium of claim 11, wherein at each grid point P=(x, y) in an x-y coordinate, the Jones matrix is a 2 by 2 matrix
$$[ \begin{matrix}{J}_{xx} ( P ) & {J}_{xy} ( P ) \\ {J}_{yx} ( P ) & {J}_{yy} ( P )\end{matrix} ] ,$$
wherein
Jₓₓ converts an x-polarized electrical field at the lens pupil entrance to an x-polarized electrical field at the lens pupil exit;
J_{xy} converts a y-polarized electrical field at the lens pupil entrance to an x-polarized electrical field at the lens pupil exit;
J_{yx} converts an x-polarized electrical field at the lens pupil entrance to a y-polarized electrical field at the lens pupil exit; and
J_{yy} converts a y-polarized electrical field at the lens pupil entrance to a y-polarized electrical field at the lens pupil exit.

13. The computer-readable storage medium of claim 10, wherein the vectorial matrix at each grid point can include:
a Muller matrix;
a Jones matrix; or
a coherency transfer matrix.

14. The computer-readable storage medium of claim 9, wherein incorporating the pupil-polarization model into the lithography model involves modifying a transfer matrix of the lithography model with the vectorial matrix, wherein the transfer matrix does not include the pupil-induced polarization effect.

15. The computer-readable storage medium of claim 14, wherein modifying the transfer matrix of the lithography model with the vectorial matrix involves multiplying a total transfer matrix by the vectorial matrix.

16. The computer-readable storage medium of claim 14, wherein the method further comprises extracting kernels for the lithography model from the modified transfer matrix.

17. An apparatus that accurately models polarization effects in an optical lithography system for manufacturing integrated circuits, comprising:
a receiving mechanism configured to receive a grid map for a lens pupil in the optical lithography system;
a constructing mechanism configured to construct a pupil-polarization model by defining a vectorial matrix at each grid point in the grid map, wherein the vectorial matrix specifies a pupil-induced polarization effect on an incoming optical field at the grid point; and
an incorporating mechanism configured to enhance a lithography model for the optical lithography system by incorporating the pupil-polarization model into the lithography model, wherein the enhanced lithography model is used to perform convolutions with circuit patterns on a mask in order to simulate optical lithography pattern printing.

18. The apparatus of claim 17, wherein the constructing mechanism is configured to specify each entry in the vectorial matrix as a function of the grid point location.

19. The apparatus of claim 17, wherein the incorporating mechanism is configured to modify a transfer matrix of the lithography model with the vectorial matrix, wherein the transfer matrix does not include the pupil-induced polarization effect.

20. The apparatus of claim 17, further comprising an extraction mechanism configured to extract kernels for the lithography model from the modified transfer matrix.
